(19) United States
(12) Patent Application Publication
(10) Pub. No.: US 2009/0249293 A1
(43) Pub. Date: Oct. 1, 2009

(54) Defining Workflow Processing Using a Static Class-Level Network in Object-Oriented Classes

(75) Inventor: Christopher Davies, Surrey (GB)

Correspondence Address: KEUSEY, TUTUNJIAN & BITETTO, P.C., 20 CROSSWAYS PARK NORTH, SUITE 210, WOODBURY, NY, 11797, US

(73) Assignee: International Business Machines Corporation, Armonk, NY (US)

(21) Appl. No.: 12/060,089

(22) Filed: Mar. 31, 2008

(51) Int. Cl. G06F 9/44

(52) U.S. Cl. 717/116

(57) ABSTRACT

Methods for configuring a computer-implemented workflow process in a computing environment include defining a workflow class using an underlying object oriented programming language of the computing environment as a metalanguage, and extending the workflow class with a static class-level model that defines a flow network,

### TECHNICAL FIELD

The present invention relates generally to methods for defining workflow processes and, more particularly, to methods for defining workflow processes using static class-level networks in object oriented classes.

### BACKGROUND

Many applications involve tracking asynchronous conversations, or workflows, between two or more parties, often remote systems. In this case, a workflow is a class of process that has instance-level data and methods to transition the data from state to state (as is normal for OO (object oriented classes), but also a “flow network” that defines the order in which the methods, or transitions, are executed in response to external events. For example, a procedure (“OnlineRegistration”) to sign up for an online shop may include various process steps such as:

(i) a user submitting an online application, including and email address;

(ii) a server sending an email to the address containing a URL that must be clicked to confirm the email's validity;

(iii) the server concurrently issuing an asynchronous credit check request on the user to an agency;

(iv) the user responding to the e-mail received in step (ii);

(v) a credit check agency responding to the request received in step (iii); and

(vi) timing out the application if the user fails to respond within a set amount of time.

In this example, events would include receiving the initial application, receiving the user's confirmation, receiving the credit agency's reply, and the expiring of the timeout interval. The flow network will define which operations are performed in response to which events, or in other terms, how the workflow transitions from state to state. Such networks are often defined as finite state machines or Petri Nets, or using other known methods.

Current solutions for defining workflows typically involve the creation of two class hierarchies including a first object model that serves as a metalanguage to describe the workflows (the knowledge level), and a second object model to define the actual running instances of workflows (the operational level). Conventional workflows are defined using the first object model, and instances are created using the second object model, but which reference the workflows in order to be able to react to events as desired. This conventional method for defining workflow results in two decoupled object models, which results in following characteristics.

A workflow is defined in the terms of a set of classes. Such concepts as inheritance, extension, versioning, encapsulation and “class loading” have to be allowed for and designed into the hierarchy. The hierarchies must be designed without prior knowledge of their use. Therefore, they will tend to require data to be referenced generically (the “everything's a HashMap” approach). The processing of the flow is essentially interpreted from the flow network, requiring a separate executor to actually perform the processing. This will tend to have a detrimental effect on performance since the decoupling effect between the two class hierarchies results in a more declarative style of programming requiring such techniques as scripting and dynamic configuration.

FIG. 1 is an exemplary UML class diagram for a conventional workflow process model. The object model in FIG. 1 illustrates a general workflow system comprising a workflow class (10), place (11) and transition (12) classes which are a part of the workflow class (10) and which is related to an activity class (13), plurality of subclasses (15, 16, 17) of the activity class (13) and an instance class (18) that is related to the workflow class (10). A specific workflow class (such as OnlineRegistration discussed above) is an instance of the workflow class (10), that is populated according to some external specification with lists of Places and Transitions and the arcs between them. For instance, a workflow process can be modeled by a Petri Net graph with nodes which can either be a Place or a Transition connected by directed edges. Transitions (12) are associated with Activities (13) including, DBaccess (15), WSinvoker (16), E-mail (17), which perform the transition process and may return data.

The conventional model in FIG. 1 has various disadvantages. For instance, responsibility for and control of flow execution is distributed across at least three classes, the Workflow class (10) that defines the structure of the flow network, the Transition/Activity classes (12, 13) that define the actual processing to be performed, and the instance classes (18) that holds the Instance data they are performed on, as well as the state of the flow network. An executor for this model must be specially written to process the places and transitions in the flow network as required. Because an Activity may be called in many situations, it must have a generic interface, that is, the data supplied would normally come in the form of a map or some other generic structure, which invalidates compile-time type checking. Moreover, it is not possible to create a workflow which is an extension to an existing flow without the inheritance being encoded in the workflow somehow, and the executor understanding the inheritance model. The above-mentioned problems above are due to the fact that the underlying programming language is used as an implementation tool for the metalanguages, not as a metalanguage in its own right.

### SUMMARY OF THE INVENTION

Exemplary embodiments of the invention include methods for defining workflow processes using static class-level networks in object oriented classes. In one exemplary embodiment of the invention, a method for configuring a computer-implemented workflow process in a computing environment includes defining a workflow class using an underlying object oriented programming language of the computing environment as a metalanguage, and extending the workflow class with a static class-level model that defines a flow network, wherein in the model, all information about a structure of the workflow, as well as a state of a running instance of the workflow class, is held in one class with methods that enable the workflow class to transition from state to state in the flow network, and wherein transition execution can be routed to methods within the workflow class, giving the transition methods direct access to instance data.

In one exemplary embodiment of the invention, an object-oriented (OO) language (such as Java or other suitable OO languages) is implemented as the metalanguage. This allows for the use of OO capabilities of the language itself, including inheritance and encapsulation, wherein a new workflow class can extend an existing one, including linking into and out of a superclass's flow network to implement extra event handling. The use of an OO language also allows for processing in the existing language's runtime, which is likely to be faster by several orders of magnitude than a home-grown metalanguage processor, keeps all aspects of the flow's state and process within the scope of a single class, and allows full use of the language's typing system—thus allowing type correctness to be ensured at compile-time and workflow developers to use the type support offered by IDEs and other development tools.

These and other exemplary embodiments, features and advantages of the present invention will be described or become apparent from the following detailed description of exemplary embodiments, which is to be read in connection with the accompanying drawings.

### BRIEF DESCRIPTION OF THE DRAWINGS

FIG. 1 is an exemplary UML class diagram illustrating a conventional workflow process model.

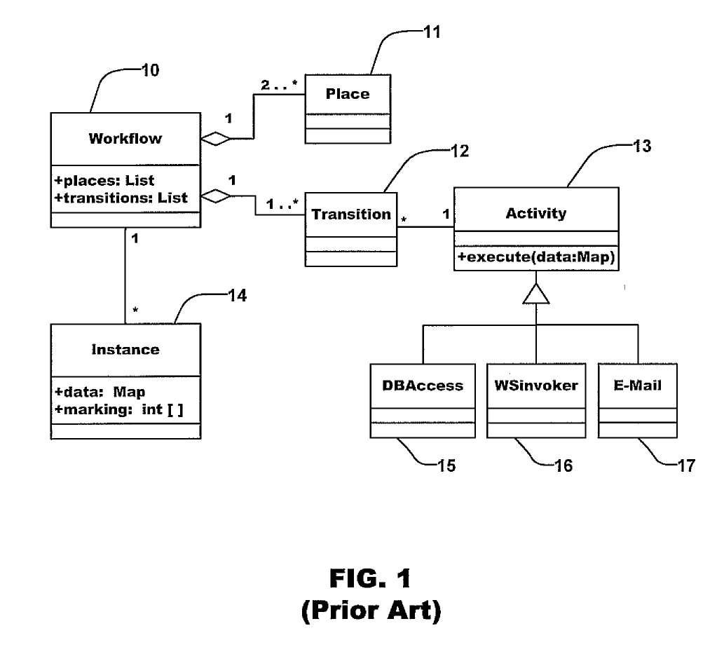

FIG. 2 is an exemplary UML class diagram illustrating a workflow process model according to an exemplary embodiment of the invention.

### DETAILED DESCRIPTION OF EXEMPLARY EMBODIMENTS

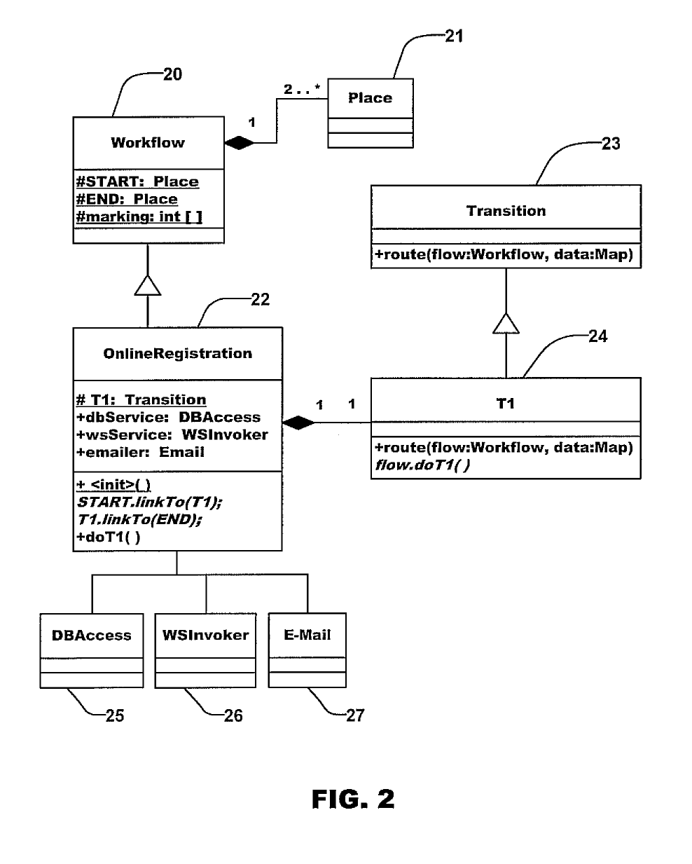

Exemplary embodiments of the invention include methods for defining workflow processes using static class-level networks in object oriented classes. FIG. 2 is an exemplary workflow object class definition diagram according to an exemplary embodiment of the invention, which illustrates a method for defining workflow processes using static class-level networks in object oriented classes. As explained below FIG. 2 illustrates an exemplary method for configuring a computer-implemented workflow process in a computing environment includes defining a workflow class using an underlying object oriented programming language of the computing environment as a metalanguage, and extending the workflow class with a static class-level model that defines a flow network, wherein in the model, all information about a structure of the workflow, as well as a state of a running instance of the workflow class, is held in one class with methods that enable the workflow class to transition from state to state in the flow network, and wherein transition execution can be routed to methods within the workflow class, giving the transition methods direct access to instance data.

Referring to FIG. 2, an object model illustrates a workflow system comprising a workflow class (20), place class (21), a workflow subclass (22) transition classes (23) and (24) and activities (25, 26, 27) In this model, all information about the structure of the workflow, as well as the state of a running instance, is held in one class (22) (e.g. OnlineRegistration). In one exemplary embodiment, this class may be a standard java class able to hold the usual instance data, and supplying normal java methods that enable the class able to transition from state to state. The class is enriched/augmented with class-level knowledge about the flow network, that is static variables for each Place and Transition in the network, and a static initializer block that links them together to make the flow network. In this model, transitions are completely owned by the enclosing class, meaning that transition execution can be safely routed to methods within the workflow class itself, giving the transition methods direct access to the instance data. There is no separately decoupled Activity layer. If the class (22) needs to call external services (25, 26, 27), these can be injected (or service-located) and called like in a normal Java Bean. Moreover, since the model augments a Java class with the workflow, a client need only be aware of the events that it receives and inform the class of these. The class itself uses the augmentation to work out which transitions this maps to—in other words which methods to call within itself.

In the exemplary model, there is no need for a specialized executor. The execution environment may be Java, which allows for increased speed. Moreover, in this model paradigm, creating a workflow that is an instance of an existing flow can use normal java inheritance. Because a subclass has knowledge of the superclass's flow network, a subclass can define its own places and transitions that link into, and thus extend, the superclass's flow network.

The required environment is minimal (in the case of Java, Java SE) and the necessary supporting types (Workflow, Place, Transition) are trivial to implement. As a result, such as model is well-suited to situations where fast, lightweight workflow is required, such as conversational-style services, application controllers and process orchestration.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention. All such changes and modifications are intended to be included within the scope of the invention as defined by the appended claims.

1. A method for configuring a computer-implemented workflow process in a computing environment, the method comprising:
defining a workflow class in memory media of the computing environment using an underlying object oriented programming language of the computing environment as a metalanguage; and
extending the workflow class with a static class-level model that defines a flow network, wherein in the model, all information about a structure of the workflow, as well as a state of a running instance of the workflow class, is held in one class with methods that enable the workflow class to transition from state to state in the flow network, wherein transition execution can be routed to methods within the workflow class, giving the transition methods direct access to instance data.
